(19) United States
(12) Patent Application Publication
(10) Pub. No.: US 2004/0205609 A1
(43) Pub. Date: Oct. 14, 2004

(54) System and method for generating and formatting a publication

(76) Inventors: John R. Milton, Corvallis, OR (US); Douglas Cogan, Brookfield, IL (US)

Correspondence Address: HEWLETT-PACKARD COMPANY, Intellectual Property Administration, P. O. Box 272400, Fort Collins, CO, 80527-2400, US

(21) Appl. No.: 09/896,567

(22) Filed: Jun. 28, 2001

(51) Int. Cl. G06F 15/00

(52) U.S. Cl. 715/522; 715/517

(57) ABSTRACT

Various systems and methods are provided for formatting a publication. In one embodiment, for example, a method is provided comprising the steps of associating, within a server, each of a plurality of content items with a select number of sub-templates selected from a plurality of sub-templates, and, generating an instance file in the server, wherein the instance file specifies a number of content items and associates a respective one of the sub-templates with each of the content items.

### TECHNICAL FIELD

The present invention is generally related to the field of information dissemination and, more particularly, is related to a system and method for generating and formatting a publication.

### BACKGROUND OF THE INVENTION

The past few years have witnessed the growth of a new type of publication, the electronic publication. Readers of these publications typically sign onto the Internet through their computer, and read the publications online. Some of these publications allow users to state personal preferences on what type of material they want to read. Often, these personalized electronic publications include advertising, placed along edges of the publications or within the content of publications.

While these electronic publications have been an interesting development in the distribution of information, they still represent a tiny fraction of the information that is published. Many readers of these electronic publications complain that they are very difficult to read, especially for long periods of time. While it might be convenient for a reader to sign onto the Internet to look at a news web site for a brief summary of late breaking news, this reader would most likely only spend a few minutes at the site, and would likely still subscribe to the more traditional print media such as Newsweek or the Washington Post. He or she would also likely spend significantly more time reading a more traditional printed publication than the electronic publication, and correspondingly would spend more time being exposed to the ads in the traditional printed publication. Accordingly, printed publications continue to flourish today more than five centuries after mass production of them first became possible.

In addition, there are many new technologies that may be used to present information to a user. Electronic publications typically have been viewed through a screen of a personal computer. However, new means of information exchange exist now and will proliferate in the future. Such means include, for example, Palm Pilot™ computers, personal digital assistants, personal appliances, pagers, cellular telephones, and other means of information exchange and presentation.

### SUMMARY OF THE INVENTION

In light of the forgoing, the present invention provides for various systems and methods for formatting a publication. In one embodiment, for example, a method is provided comprising the steps of associating, within a server, each of a plurality of content items with a select number of sub-templates selected from a plurality of sub-templates, and, generating an instance file in the server, wherein the instance file specifies a number of content items and associates a respective one of the sub-templates with each of the content items.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a publishing network according to an embodiment of the present invention;

FIG. 2 is a functional block diagram of publication distribution logic executed on a server in the publishing network of FIG. 1;

FIG. 3 is a functional block diagram of the workflow employed in the publication distribution logic of FIG. 2;

FIG. 4 is a flow chart of functionality of the publication distribution logic of FIG. 2;

FIG. 5-7 are flow charts of further functionality of the publication distribution logic of FIG. 2; and

FIG. 8 is a schematic view of an example of displayed output produced by the publishing network of FIG. 1.

### DETAILED DESCRIPTION OF THE INVENTION

According to the present invention, sub-templates are used in formatting an electronic publication. The sub-templates allow placement of multiple similar items, such as comic strips, within a single electronic publication. The number and type of items placed may be varied, without use of separate templates for each possible configuration.

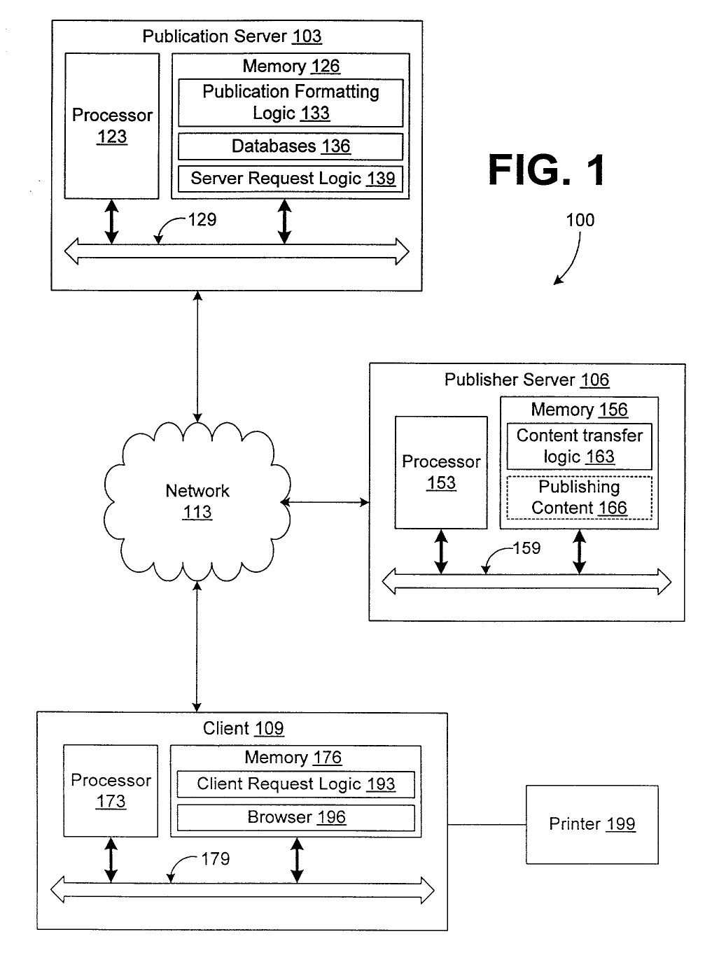

With reference to FIG. 1, shown is a publishing network 100 according to an embodiment of the present invention. The publishing network 100 includes a publication server 103, a publisher server 106, and a client 109. The publication server 103, publisher server 106, and the client 109 are in data communication with each other by way of a network 113. The network 113 may be, for example, the Internet, wide area networks (WANs), local area networks, wireless networks, or other suitable networks, etc. The network 113 may represent a combination of two or more of the above networks as well.

The publication server 103 includes a processor circuit that has a processor 123 and a memory 126, both of which are coupled to a local interface 129. The local interface 129 may be, for example, a data bus with an accompanying control bus as known by those with ordinary skill in the art.

Stored on the memory 126 are publication formatting logic 133, one or more databases 136, and server request logic 139. The publication formatting logic 133 is executable by the processor 123 to generate a publication in digital form in a format that is recognizable by the presentation platform embodied in the client 109. Specifically, the publication formatting logic 133 receives a request for a particular publication and then generates the publication in the desired digital format that is transmitted to a presentation platform such as on the client 109, as will be discussed. The databases 136 contain the content that is used to generate the publication as well as other information and data files employed by the publication formatting logic 133.

The publisher server 106 has a processor circuit that includes a processor 153 and a memory 156, both of which are coupled to a local interface 159. The local interface 159 may be, for example, a data bus with an accompanying control bus as known by those with ordinary skill in the art. Stored on the memory 156 is content transfer logic 163 and publishing content 166. The content transfer logic 163 is executable by the processor 153 to transmit the publishing content 166 to the publication server 103.

The client 109 also includes a processor circuit that features a processor 173 and a memory 176, both of which are coupled to a local interface 179. The local interface 179 may be, for example, a data bus with an accompanying control bus as known by those with ordinary skill in the art. Stored on the memory 176 and executable by the processor 173 are client request logic 193 and a browser 196 according to one embodiment of the present invention. The client request logic 193 is executable by the processor 173 to request a desired publication from the publication server 103. The client 109 is linked to a presentation platform, a printer 199, to print the publication, sent by the publication server as a suitably encoded output file.

The memories 126,156, and 176 may include both volatile and nonvolatile memory components. Volatile components are those that do not retain data values upon loss of power. Conversely, nonvolatile components retain data upon a loss of power. Thus, the memories 126,156, and 176 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

In addition, each of the processors 123, 153, and 173 may represent multiple processors that operate in parallel. Similarly, each of the memories 126,156, and 176 may represent multiple memories that are used in conjunction with the respective parallel processors. In such a case, each of the local interfaces 129,159, and 179 may be an appropriate network that facilitates communication between any two of the multiple processors or between any one processor and any one memory, etc. In addition, the processors 123,153, and 173; memories 126, 156, and 176; and local interfaces 129,159, and 179 may be electrical or optical in nature. The memories 126,156, and 176 may also be magnetic in nature.

User input devices (not shown) that may be employed with the publication server 103, the publisher server 106, and the client 109 include, for example, but are not limited to, scanners, keyboards, keypads, touch pads, touch screens, microphones, mice, joysticks, or one or more push buttons, etc. User output devices may include display screens, indicator lights, speakers, printers, etc. The particular display devices may further comprise, for example, a liquid crystal display screen, a gas plasma-based flat panel display, indicator lights, light emitting diodes, and other display devices.

In light of the foregoing discussion of the publishing network 100, the following are examples of the general operation of the publishing network 100. To begin, the client 109 executes the client request logic 193 to generate a request for a particular publication to present to the user. Pursuant to the client request logic 193, the user may be able to generate the request on demand, or alternatively, the client request logic 193 may generate the request in an automated fashion periodically according to predefined parameters entered by the user. The request is then transmitted to the publication server 103 by way of the network 113.

Alternatively, a request for a particular publication may be generated in the publication server 103 pursuant to the server request logic 139. In particular, the server request logic 139 may be preset to specify one or more publications to be delivered to a user periodically at specific times. To this end, the server request logic 139 may include a scheduling database, for example, that includes prescription and delivery information. Such a database may be automatically searched to generate a request for a publication to be delivered to a user. The precise publication(s) and delivery times, etc., may be determined when the user first subscribes to the publication service.

Whether generated in the client 109 or in the publication server 103, the request for a publication is provided to the publication formatting logic 133. The request includes information such as user information and identifiers corresponding to desired content items, as well as other information as needed. The user information may include identifying information about the user, such as the user's name or nickname. In addition, the user information may include information such as user preferences, for example user document layout preferences. Further, the user information may include information on the user's presentation platform. The desired content items may include indications of one or more content items desired by the user. The content items may be items of various sorts including images and/or text, such as comic strips, pictures, advice or opinion columns, and news stories.

The publication server 103 then reacts to the request by generating the desired publication. In particular, the publication server 103 gathers the content of the publication from the databases 136 and generates the publication in a digital format that may be printed or otherwise recognized by the desired presentation platform. The publication server 103 pursuant to the publication formatting logic 133 formats and transmits the publication to the presentation platform such as, for example, the browser 196 executed on the client 109. As explained in greater detail below, the publication formatting logic 133 first produces an instance file, which for example includes call-outs or indications associated with the content items, and the templates with various sub-templates to be used. The instance file is then used to produce a publication output file, which is sent to the client.

Upon receiving the publication, the presentation platform such as, for example, the printer 199 linked to the client 109, proceeds to perform all necessary operations to present the information to the user. In particular, various presentation platforms may be employed to present the publication to the user in one of several forms. For example, the publication may be presented as a printed document, a display on a display device, or other types of presentation modes. Thus, the concept of “presenting a publication to a user” as contemplated herein is defined broadly as depicting a publication in a form that is perceivable by a user so that the user may comprehend the information contained therein. The term “presentation platform” is defined herein as the system or device that is employed to present the publication to the user. A particular presentation platform may be implemented in terms of software executed on general purpose hardware, dedicated hardware that performs the functional aspects of the particular presentation platform, or a combination of software/general purpose hardware and dedicated hardware.

For example, one presentation platform may include a client 109 with the attached printer 199 to print the publication in the form of a document. In this regard, logic would be stored on the memory 176 and executed by the processor 173 to print out a publication received from the publication server 103 on the attached printer 199. Alternatively, the presentation platform may include the client 109 executing the browser 196 to display the publication. As a further alternative, an electronic mail service or mail reader may be employed in the place of the browser 196.

Further presentation platforms may include a pager device, cellular telephone device, personal appliance, personal digital assistants, or other mobile device that provides a screen or other means for displaying information to a user. For example, a pager or cellular telephone may include a processor circuit with a processor and a memory. Stored on this memory and executable by the processor may be, for example, a mini browser, electronic mail reader, or other logic to present the publication to the user via an appropriate display device, etc.

The presentation platforms discussed herein are provided as examples of a number of potential presentation platforms for which a publication may be prepared by the publication distribution logic 133. It will be appreciated other presentation platforms are known to those with skilled in the art. Such presentation platforms fall within the scope of the present invention. The publication formatting logic 133 serves to generate a publication in a digital format that is recognizable by any one of a number of prospective presentation platforms.

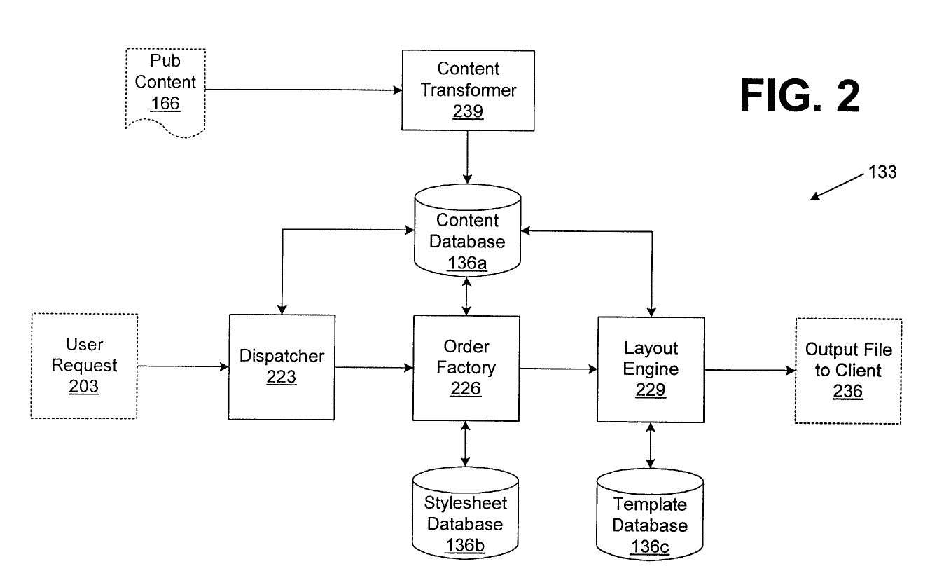

With reference to FIG. 2, shown is a functional block diagram of the publication formatting logic 133 (FIG.1) according to an embodiment of the present invention. As shown in FIG. 2, each block represents a module, object, or other grouping or encapsulation of underlying functionality as implemented in programming code. However, the same underlying functionality may exist in one or more modules, objects, or other groupings or encapsulations that differ from those shown in FIG. 2 without departing from the present invention as defined by the appended claims.

To begin, the publication formatting logic 133 receives a user request 203 from either the client 109 (FIG. 1) pursuant to the client request logic 193 (FIG. 1) or from the publication server 103 (FIG. 1) pursuant to the server request logic 139 (FIG. 1) as discussed above.

The publication formatting logic 133 also includes a dispatcher 223, an order factory 226, and a layout engine 229 that generates an output file 236. The output file 236 is transmitted to the client 109. A content database 136a, a stylesheet database 136b, and a template database 136c, are linked to the publication formatting logic 133. The publication formatting logic 133 also includes a content transformer 239 that receives the publication content 166 from the publisher server 106 (FIG. 1) and transforms it into a format for storage in the content database 136a. The format employed to store the publication content 166 on the content database 136a may involve the use of, for example, Extensible Markup Language (XML) or other suitable language. The content transformer 239 essentially parses publishing content 166 received from the publisher server 106 and transforms it into appropriate format to be stored on the content database 136a. The specific format employed is such to allow the content to be recognized and manipulated by the other modules, objects, or other elements of the publication formatting logic 133.

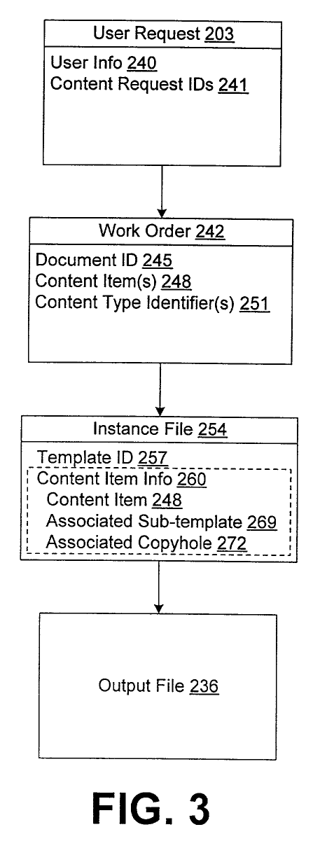

With reference in addition to FIG. 3, operation of the publication formatting logic 133 begins with generation of the request 203 either in the publication server 103 (FIG. 1) or in the client 109 (FIG. 1), which is then received by the dispatcher 223. The request 203 includes, for example, user information 240 and one or more content request identifiers 241. It is understood that the request 203 may also include other information as appropriate or necessary to the formation of a particular publication.

Upon receiving the request 203, the dispatcher 223 retrieves information associated with the content items from the content database 136a and generates a work order 242 that is supplied to the order factory 226. The work order 242 includes a document identifier 245, one or more content items 248, and content type identifiers 251 that are associated with the content items 248, respectively. The document identifier 245 indicates the type of document (e.g., comics, sports, etc.). The content items 248 may comprise, for example, the actual content in the form of text, images, or other content, or the content items 248 may comprise file locations, such as uniform resource indicators (URIs), pointers, and/or file pathways that point to the actual content stored in the content database 136a or other memory location accessible by the publication server 103 (FIG. 1). The content files may include files for user-specific content items, such as those corresponding to the content request identifiers 241, as well as document-specific content files corresponding to the type of document requested.

The order factory 226 then processes the work order 242 to produce an instance file 254, using one or more stylesheets from the stylesheet database 136b and/or information from the content database 136a. The instance file 254 includes a template identifier 257, and content item information 260. The content item information 260 includes information for each of the content items 248 listed therein. In this respect, the content item information 260 may include the respective content items 248 specified in association with a sub-template 269 (if any) or specified in association with a respective copyhole 272 where the content item is to be placed in the resulting document. Note that the content item 248 may be the actual content itself or a reference (i.e. URI) to the respective content item 248.

The instance file 254 is forwarded to the layout engine 229. The layout engine 229 uses the information in the instance file 254, as well as additional information from the template database 136c and/or the content database 136a, to create the output file 236 to send to the client 109 (FIG. 1). For example, the layout engine 229 examines the instance file 254 and determines which template 257 should be used for the document(s) as well as the content items 248 to inset into the documents. The layout engine 229 also identifies any sub-templates 269 named in the instance file 254 that are to be used in placing specified ones of the content items 248 into the document. The sub-templates 269 are included, for example, in the template 257 or may be stored in a file or database, etc., in another memory location as can be appreciated by one with ordinary skill in the art. The layout engine 229 then inserts the content items 248 into the document as specified by the template 257, thereby creating the output file 236. The output file 236 thus comprises the document embodied in a format that is recognizable by the respective presentation platform. It will be appreciated that layout engine 229 may employ multiple steps and/or may involve storing content or other intermediate files in a random access memory during creation of the output file 236.

The layout engine 229 as shown performs various functions. Some of these functions may be, for example, transforming an extensible markup language (XML) file to another XML file or into a graphics file. Other functions may involve extracting metadata from a file, generating a summary of a file, or performing various housekeeping functions such as deleting intermediate files out of memory, etc.

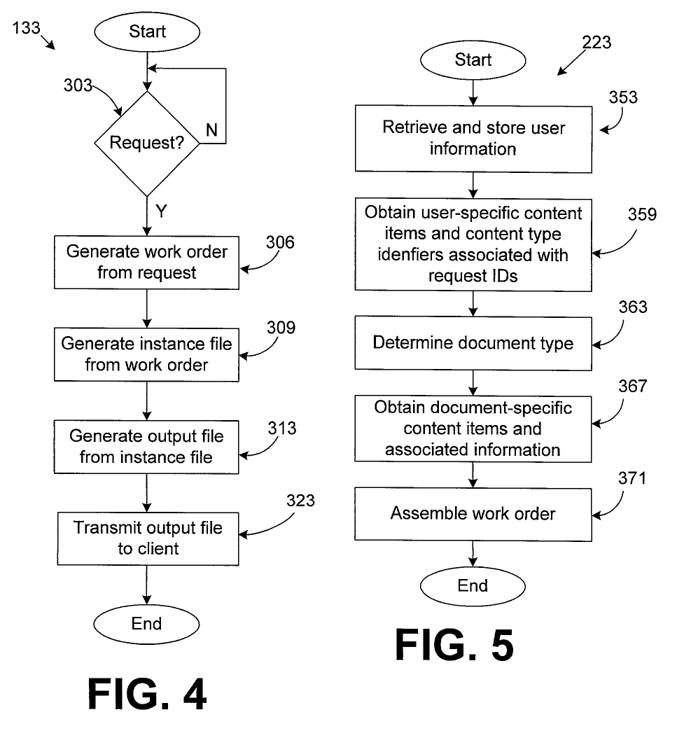

Referring next to FIG. 4, a flow chart is shown of the general functionality (logical functions) of the publication formatting logic 133. Alternatively, the flow chart of FIG. 4 may represent the method steps taken in executing the publication formatting logic 133. In block 303 the dispatcher 223 waits for a request 203 (FIG. 2) to be received from either the publication server 103 (FIG. 1) pursuant to the server request logic 139, or from the client 109 pursuant to the client request logic 193 (FIG. 1). Once the request 203 has been received, the dispatcher 223 moves on to block 306, in which the work order 242 is generated from the request 203. Thereafter, in block 309 the order factory 226 generates the instance file 254, using the work order 242. In block 313 the layout engine 229 generates the output file 236 from the instance file 254. Finally, in block 323, the publication server 103 transmits the output file 236 (FIG. 2) to the client 109 (FIG. 1).

FIG. 5 shows a flow chart of the dispatcher 223 according to an aspect of the present invention. Alternatively, the flow chart of FIG. 5 may represent the method steps taken by the dispatcher 223. In block 353 the dispatcher retrieves or extracts the user information 240 from the user request 203 (FIG. 3). As noted above, the user information 240 may include identifying information about the user, such as the user's name or nickname. In addition, the user information 240 may include information such as user preferences, for example user document layout preferences. Further, the user information 240 may include information on the user's presentation platform. It will be appreciated that alternatively the user request 203 need not include user information 240, in which case block 353 may be skipped.

In block 359 the dispatcher obtains user-specific content items 248 and the content type identifiers 251 associated therewith that are associated with the content request identifiers 241. In this respect, the content request identifiers 241 point to the content items 248 and their associated content type identifiers 251. The content type identifiers 251 describe a format type of the respective content item 248. For example, the content item 248 may be a comic strip. The content type identifier 251 may thus identify the content item 248 as a comic strip. Ultimately, the content type identifiers 251 provide information that is used in determining which sub-template 269 is to be employed to place the respective content item 248 into the document embodied in the output file 236.

The dispatcher 223 may employ a key or look-up table to associate the content request identifiers 241 with the corresponding content items 248 in the content database 136a. Some or all of the user-specific content items require the use of sub-templates for placement within the document embodied in the output file 236. In addition, other information associated with the user- specified content items may be obtained in block 359.

The use of sub-templates to place content items in a document provides for the creation of undefined regions within such a document. Specifically, an undefined region is region in a document where a variety of differently sized content items may be placed using one or more sub-templates. Thus, the exact location of the content item within an undefined region may depend upon the number and/or size of the other content items that are placed in the undefined region. Also, in a case where there is a particular order in which items appear in such an undefined region, the actual order may be designated by the order in which content items are listed in the work order 242 and instance file 254.

Next, in block 363 the document type is determined. The document may be one of a variety of types of document, such as a comics paper, an international news document, or a sports news document. The document type may be determined from examining the type of documents requested in the user request 203. Alternatively, the user request 203 may have a separate indicator of the type of document requested. Additionally, it will be appreciated that alternatively the publishing network 100 may be configured to handle a single document type, in which case the block 363 may be omitted or skipped.

Thereafter, in block 367, document-specific content items or document specific content file locations and associated information are obtained from the content database 136a. The document-specific content may be, for example, standard titles and formatting, or content directed to readers of a specific type of document (e.g., targeted advertisements) and/or updated content provided to readers of various types of documents or other information. The document-specific content items and or document-specific content file locations and associated information may be selected based on the document type and/or the user information 240.

In block 371 the work order 242 is assembled. The work order 242 may be a text file, XML file, or other file type with separate lines or sections for the document identifier 245 and for each of the content items 248. The information associated with each of the content items 248 may include, for example, a content type identifier 251 and other information. The information for the content items 248 may be in a specified order, for example with information associated with the document-specific content items preceding information associated with the user-specific content items.

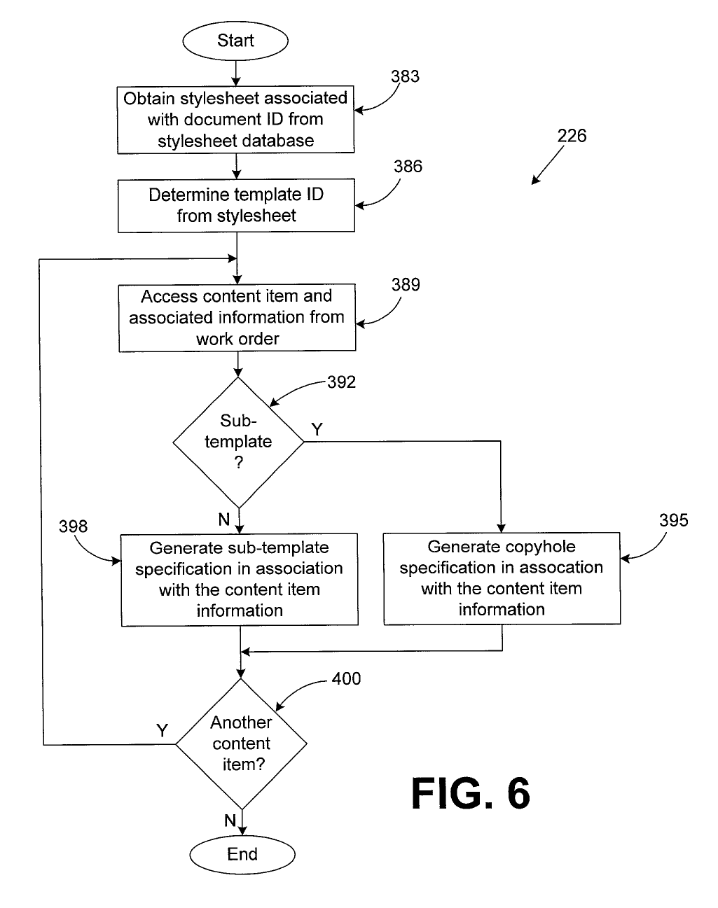

FIG. 6 shows a flow chart of the order factory 226 according to an aspect of the present invention. Alternatively, the flow chart of FIG. 6 may represent the method steps taken by the order factory 226. In block 383 the order factory 226 obtains a stylesheet, associated with the document identifier 245, from the stylesheet database 136b. The stylesheet is a file that generates mark up to associate the content items with locations in the document where they are to be placed. It will be appreciated that, instead of a database of different stylesheets, there may be one stylesheet that performs the same functions for a variety of types of documents.

In block 386, the template identifier 257, corresponding to the template for the document, is determined. The template identifier 257 may be specified in the stylesheet, or may be determined from the document identifier 245. It will be appreciated that the template identifier 257 may be stored in the instance file 254, or alternatively may be otherwise transmitted to the layout engine 229.

For a given content item 248, the order factory 226 accesses (from the work order 242) the information concerning that content item in block 389. As noted above, the information concerning the content item may include the content item 248 (such as the content itself or a content file location) and a content type identifier 251 (if applicable). In block 392 the order factory 226 makes a determination as to whether the content item 248 associated with the information is to be placed in the document using a sub-template 269 as indicated by any associated content type identifier 251. If not, then in block 395 the order factory 226 generates the content item information 260 that specifies the copyhole in association with the content item 248. The term “copyhole” as used herein, refers to a location where content (copy) is to be placed in a document. The physical layout of a particular copyhole is generally described in the template 257.

However, if a sub-template is to be used, then in block 398 the order factory 226 generates content item information 260 that specifies the sub-template 269 to be employed in association with the content item 248. Thus, such information includes, for example, a reference to a respective sub-template 269 that is employed by the layout engine 229 in the placement of the respective the content item 248 in the resulting document. Note that the specific sub-template 269 may be determined based upon the content type identifier 251 in the work order 242. For example, if the content type identifier 251 specifies a “comic,” then the sub-template 269 for comics is associated with the respective content item 248. All such information is written to the instance file 254.

In block 400 a check is made for any unprocessed content item 248 in the work order 242. If there is another content item 248 to process, the order factory 226 returns to block 389. If not, the instance file 254 is forwarded to the layout engine 229.

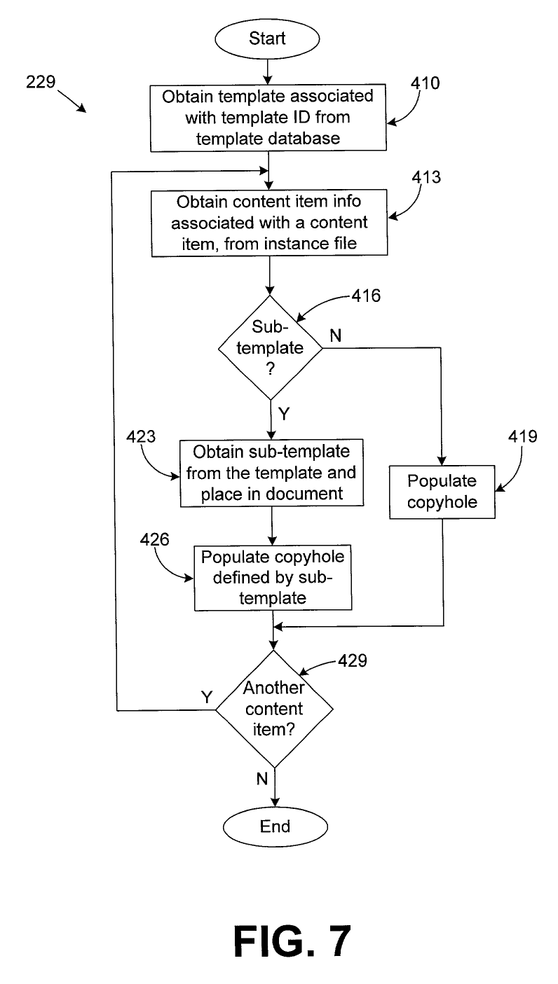

FIG. 7 shows a flow chart of the layout engine 229 according to an aspect of the present invention. Alternatively, the flow chart of FIG. 7 may represent the method steps taken by the layout engine 229. In block 410 the layout engine 229 obtains a template from the template database 136c that is associated with the template identifier 257 in the instance file 254.

In block 413 the layout engine 229 obtains the content item information 260, from the instance file 254, that is associated with one of the content items 248. In block 416, the layout engine 229 determines whether the content item 248 is specified in association with a specific sub-template 269. If not, then the layout engine 229 proceeds to block 419 in which the copyhole that is specified is populated with the content item 248. Otherwise, the layout engine 229 proceeds to block 423 in which the specified sub-template 269 is obtained from the previously identified template and placed in the resulting document embodied in the form of the output file 236. Thereafter, in block 426 the copyholes defined by the newly placed sub-template 269 is populated with the corresponding content item 248. Note that in both blocks 419 and 426, the content item 248 may be retrieved from a remote memory location such as the content database 136a if necessary. Alternatively, the content 248 may be retrieved from the instance file 254 if the actual content is included therein as opposed to a URI associated with the content item 248 as described previously.

For some documents, the layout engine 229 may check whether the content item is placed outside of the current layout page. If so, the layout engine 229 then places the content at the top of the next page in the undefined region in situations where there are no page number restrictions that prevent such action. If the number of pages are restricted such that a new page cannot be created to accommodate the content item 248, then the content item 248 may be discarded. Thus, the undefined regions of multiple pages in which the sub-templates 269 are located may be linked together so that content overflowing the undefined region of one page automatically is placed at the top of the undefined region of the next page. The order in which content items 248 appear in the undefined regions is determined, for example, by the order in which the content items 248 appear in the instance file 254, the work order 242, and the user request 203, etc.

Finally, in block 434, a check is made as to whether another content item 248 needs to be placed. If so, the layout engine reverts to block 413. If not, the resulting output file 236 into which the content items 248 have been placed, is transmitted to the user.

Additionally, the sub-templates 269 may be sized such that one sub-template 269 has a height which is approximately a whole-number multiple of the height of another sub-template 269. Thus, for example, one sub-template 269 may be about twice the height of another. The sub-templates 269 may be sized so as to avoid excessive white space at the bottom of a page.

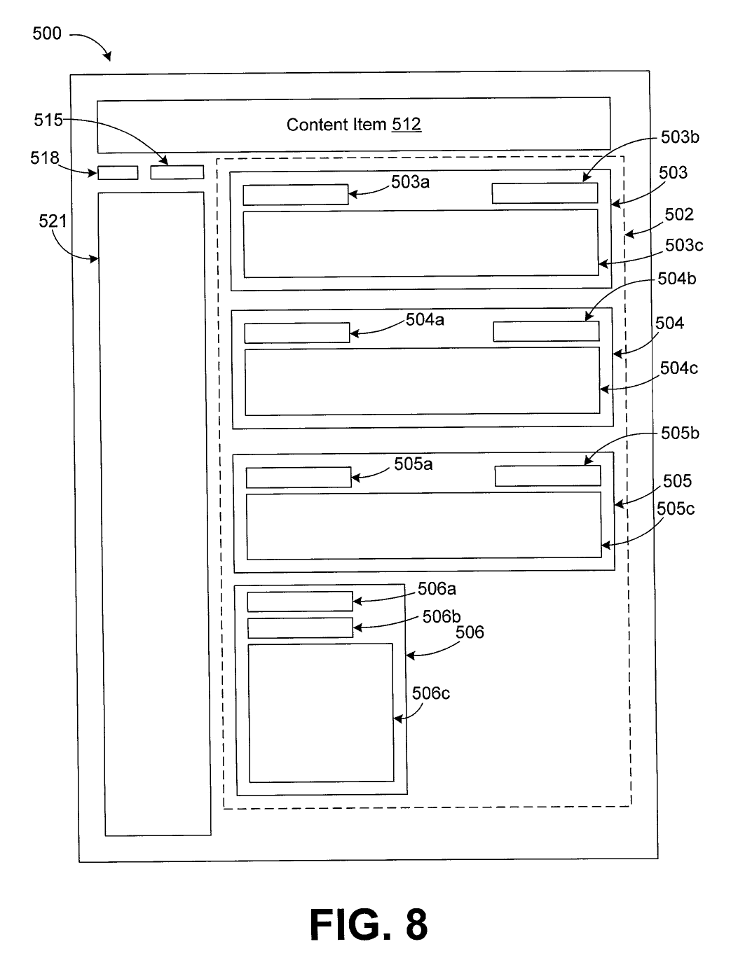

FIG. 8 shows an example layout 500 created according to the present invention. The layout 500 includes an undefined region 502 into which a number of sub-templates 503, 504, and 505 of a first type, and a sub-template 506 of a second type are placed. The first-type sub-template 503 is filled by content items 503a, 503b, and 503c. The content items 503a-503c may be, respectively, a comic title, a date, and a comic strip, for example. Corresponding content items populate the templates 504 and 505.

The second-type template 506 is filled by content items 506a, 506b, and 506c, which may be a comic title, a date, and a comic panel, respectively.

The layout 500 includes additional content items 512-521 that are not in sub-templates, and which are placed in corresponding copyholes. The additional content items 512-521 may be any of a variety of content items, which may make reference to the user. For example, the item 512 may be a banner ad, the item 515 may be a logo, the item 518 may be the user's name, and the item 521 may content a set of links to other locations, such as other web pages.

It will be appreciated that the layout 500 is but one specific example of the great variety of layouts that may be produced using the systems and method/process described above.

Among the advantages provided by the present invention is the ability to populate layouts in a flexible manner by maintaining a number of sub-templates associated with a specific template. In such a case, then documents with a different layout configuration may be created using the same template, only different combinations of sub-templates as can be appreciated by those with ordinary skill in the art.

The alternative is to maintain a large number of templates, each of the templates handling one of a variety of possible layout configurations. Changing content layout associated with a respective template is thus a relatively easy manner, by changing the some or all of the sub-templates associated therewith, as opposed to revising a large number of mutually exclusive templates.

Referring back to FIG. 1, although the logic 133, 139, 163, 193 and 196 of the present invention is embodied in software as discussed above, as an alternative the logic 133, 139, 163, 193, and 196 may also be embodied in hardware or a combination of software and hardware. If embodied in hardware, the logic 133, 139, 163, 193, and 196 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagrams and/or flow charts of FIGS. 2-7 show the architecture, functionality, and operation of an implementation of the logic 133. If embodied in software, each block may represent a module, segment, or portion of code that comprises one or more executable instructions to implement the specified logical function(s). If embodied in hardware, each block may represent a circuit or a number of interconnected circuits to implement the specified logical function(s). Although the block diagrams and/or flow charts of FIGS. 2-7 may show a specific order of execution, it is understood that the order of execution may differ from that which is depicted. For example, the order of execution of two or more blocks may be scrambled relative to the order shown. Also, two or more blocks shown in succession in FIGS. 2-7 may be executed concurrently or with partial concurrence. It is understood that all such variations are within the scope of the present invention.

Also, the logic 133 can be embodied in any computer-readable medium for use by or in connection with an instruction execution system such as a computer/processor based system or other system that can fetch or obtain the logic from the computer-readable medium and execute the instructions contained therein. In the context of this document, a “computer-readable medium” can be any medium that can contain, store, or maintain the logic 133 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

The present invention may provide distinct advantages. Specifically, it may allow increased flexibility and require fewer templates to be maintained. Because of the use of sub-templates, separates templates are not required for each possible combination of different types of content items. In addition, a layout revision may be accomplished by revision of one or more of a relatively small number of sub-templates, rather than revising a relatively large number of unique templates, as may be required when sub-templates are not used.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (ie., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/We claim:

1. A method for formatting a publication, comprising:
associating, within a server, each of a plurality of content items with a select number of sub-templates selected from a plurality of sub-templates; and
generating an instance file in the server, wherein the instance file specifies a number of content items and associates a respective one of the sub-templates with each of the content items.

2. The method of claim 1, wherein at least some of the content items are user-specified content items, and wherein the generating is done in response to a request, wherein the request includes one or more request identifiers corresponding to the user-specified content items.

3. The method of claim 2, further comprising, prior to the generating, receiving the request from a client computer.

4. The method of claim 2, wherein the instance file also includes document-specific content items not corresponding to the request identifiers.

5. The method of claim 1, further comprising generating an output file using the instance file and a template, the template specifying the sub-template.

6. The method of claim 5, wherein the template includes an undefined region, and wherein the generating of the output file includes employing the sub-templates in placing content items in the undefined region.

7. The method of claim 6, wherein the template also includes defined location copyholes, and wherein the generating of the output file includes placing content items not associated with sub-templates into the defined location copyholes.

8. The method of claim 5, wherein the templates include differently sized ones of the sub-templates.

9. The method of claim 8, wherein one of the sub-templates has a height that is a whole number multiple of a height of another of the sub-templates.

10. A system in a server for formatting a publication, comprising:
means for associating, within the server, each of a plurality of content items with a select number of sub-templates selected from a plurality of sub-templates; and
means for generating an instance file in the server, wherein the instance file specifies a number of content items and associates a respective one of the sub-templates with each of the content items.

11. The system of claim 10, wherein the means for generating includes means for generating in response to a request, and wherein the request includes an indication of at least some of the one or more content items.

12. The system of claim 11, further comprising means for receiving the request from a client computer.

13. The system of claim 11, wherein the instance file also includes document-specific content items not corresponding to the request identifiers.

14. The system of claim 10, further comprising means for generating an output file using the instance file and a template, the template specifying the sub-templates.

15. The system of claim 14, wherein the template includes an undefined region, and wherein the means for generating the output file includes means for means for employing the sub-templates to place the content items in the undefined region.

16. The system of claim 15, wherein the template also includes a number of defined location copyholes, and wherein the means for generating the output file includes means for placing respective ones of the content items not associated with the sub-templates into the defined location copyholes.

17. The system of claim 10, wherein the sub-templates further comprise differently sized sub-templates.

18. The system of claim 17, wherein one of the sub-templates has a height that is a whole number multiple of a height of another of the sub-templates.

19. A system for formatting a publication, comprising:
a processor circuit having a processor and a memory; and
publication formatting logic stored in the memory and executable by the processor, the publication formatting logic including:
logic that associates each of a plurality of content items with a select number of sub-templates selected from a plurality of sub-templates; and
logic that generates an instance file in the server, wherein the instance file specifies a number of content items and associates a respective one of the sub-templates with each of the content items.

20. The system of claim 19, wherein the logic that generates the instance file includes logic that generates the instance file in response to a request, and wherein the request includes an indication of at least some of the one or more content items.

21. The system of claim 20, further comprising logic that receives the request from a client computer.

22. The system of claim 20, wherein the instance file also includes document-specific content items not corresponding to the request identifiers.

23. The system of claim 19, further comprising logic that generates an output file using the instance file and a template, the template specifying the sub-templates.

24. The system of claim 23, wherein the template includes an undefined region, and wherein the logic that generates the output file includes logic that employs the sub-templates in placing content items in the undefined region.

25. The system of claim 19, wherein the template also includes a number of defined location copyholes, and wherein the logic that generates the output file includes logic that places content items not associated with the sub-templates into the defined location copyholes.

26. The system of claim 23, wherein the sub-templates include differently sized sub-templates.

27. The system of claim 19, wherein one of the sub-templates has a height that is a whole number multiple of a height of another of the sub-template templates.
